(19) United States
(12) Patent Application Publication
(10) Pub. No.: US 2019/0250878 A1
(43) Pub. Date: Aug. 15, 2019

(54) REMOTE CONTROL FOR AN AUDIO MONITORING SYSTEM

(71) Applicant: Disney Enterprises, Inc., Burbank, CA (US)

(72) Inventors: Daniel Abrams, Woodland Hills, CA (US); Ryan Stern, Los Angeles, CA (US); Mark Lindauer, Oak Park, CA (US); Andrew Winderbaum, Los Angeles, CA (US)

(21) Appl. No.: 15/898,038

(22) Filed: Feb. 15, 2018

(51) Int. Cl. G06F 3/16; G06F 3/0484; G06F 3/0488

(52) U.S. Cl. CPC G06F 3/165; G06F 3/0488; G06F 3/04847; G06F 3/167

(57) ABSTRACT

A remote control has a physical subsystem and a graphical subsystem. The physical subsystem has a hardware command processor and one or more physical input devices. The hardware command processor determines an input for an audio command based on activation of the one or more physical input devices. Further, the hardware command processor translates the audio command into a format understood by an audio monitoring system. In addition, the hardware command processor sends the translated audio command to the audio monitoring system so that the audio monitoring system adjusts one or more audio output devices based on the audio command. The audio monitoring system is remotely situated from the physical subsystem. Further, the graphical subsystem has a display screen and a display processor rendering a graphical user interface on the display screen.

### BACKGROUND

### 1. Field

This disclosure generally relates to the field of audio systems. More particularly, the disclosure relates to a configuration for monitoring audio.

### 2. General Background

Conventional audio equipment for theater and/or home theater environments is typically configured for specific audio film formats. For instance, a first audio monitoring system may monitor audio in a theatre having a 5.1 audio configuration (i.e., six-channel) whereas a second audio monitoring system may monitor audio in a theatre having a 7.1 surround sound audio configuration (i.e., eight-channel surround audio system). As audio formats evolve, audio operators often have to change audio equipment, which is cumbersome and resource-intensive.

### SUMMARY

In one aspect, a remote control has a physical subsystem and a graphical subsystem. The physical subsystem has a hardware command processor and one or more physical input devices. The hardware command processor determines an input for an audio command based on activation of the one or more physical input devices. Further, the hardware command processor translates the audio command into a format understood by an audio monitoring system. In addition, the hardware command processor sends the translated audio command to the audio monitoring system so that the audio monitoring system adjusts one or more audio output devices based on the audio command. The audio monitoring system is remotely situated from the physical subsystem. The audio command is provided by the hardware command processor.

The graphical subsystem has a display screen and a display processor rendering a graphical user interface on the display screen. Further, the graphical user interface depicts one or more input indicia corresponding to one or more additional audio commands. The one or more additional audio commands are distinct from the audio command. In addition, the processor sends the one or more additional audio commands to the audio monitoring system so that the audio monitoring system adjusts the one or more audio output devices based on the one or more additional audio commands. The audio monitoring system is remotely situated from the graphical subsystem.

In another aspect, a system has the aforementioned remote control in addition to the audio monitoring system. In yet another aspect, a process performs the functionality of the aforementioned remote control.

### BRIEF DESCRIPTION OF THE DRAWINGS

The above-mentioned features of the present disclosure will become more apparent with reference to the following description taken in conjunction with the accompanying drawings, wherein like reference numerals denote like elements and in which:

FIG. 1 illustrates the internal componentry of a remote control for an audio monitoring system.

FIG. 2A illustrates an example of the exterior of the remote control.

FIG. 2B illustrates an expanded view of the display screen illustrated by FIG. 2A.

FIG. 3 illustrates an audio monitoring system that uses the remote control illustrated in FIGS. 1, 2A, and 2B to control audio via an audio monitoring processor.

FIG. 4 illustrates a sound recording environment in which the remote control illustrated in FIGS. 1-3 may be used in conjunction with a mixing console.

FIG. 5 illustrates a process that may be utilized by the remote control illustrated in FIG. 1.

### DETAILED DESCRIPTION

A remote control provides control over a scalable audio monitoring system. The remote control may be a physical user interface that has hardware input indicia and software input indicia. After receiving various inputs (either hardware or software), the remote control translates the inputs into commands understood by an audio processor that processes commands for the audio monitoring system. Accordingly, the remote control may be adapted via software modifications to accommodate changes in audio formats. As a result, the same remote control may be used even when the audio monitoring system is scaled to accommodate a change in audio formats.

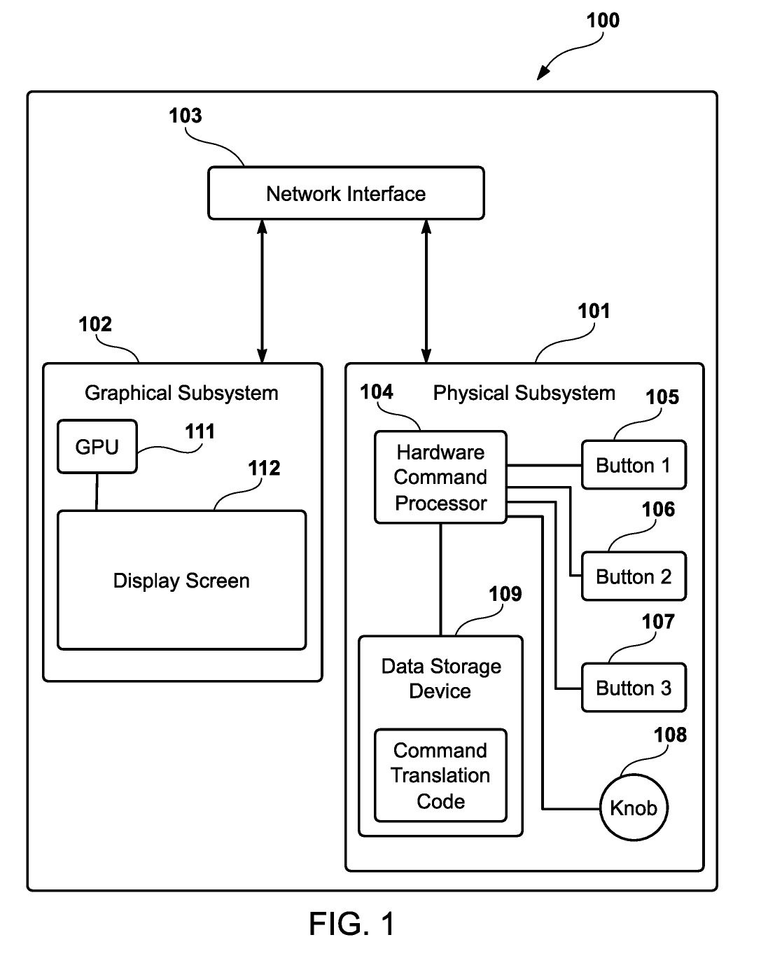

FIG. 1 illustrates the internal componentry of a remote control 100 for an audio monitoring system. The remote control 100 has two subsystems: a physical subsystem 101 and a graphical subsystem 102. Either, or both, of the subsystems 101 and 102 may receive inputs and translate those inputs into commands according to a protocol understood by an audio monitoring system. The subsystems 101 and 102 may send those translated commands via a network interface 103 (e.g., Ethernet) to the audio monitoring system.

The physical subsystem 101 may include a hardware command processor 104. In one aspect, the hardware command processor 104 receives an input command from a physical indicium adhered to, or integrated within, an enclosure of the remote control 100. For example, the physical indicium may be an assortment of buttons 105-107, a knob 108, etc. The hardware command processor 104 then executes command translation code 110, which may be stored on a data storage device 109, to read the button presses, knob control movements, or other forms of input indicia activation. Further, the hardware command processor 104 may execute the command translation code 110 to translate the commands into the protocol of the audio monitoring system. The hardware command processor 104 may then send the translated commands to the audio monitoring system via the network interface 103.

Further, the hardware command processor 104 may also receive commands from the audio monitoring system via the network interface 103. For example, the audio monitoring system may send a command to display certain feedback (e.g., lighting an indicator lamp) to the physical subsystem 101. The hardware command processor 104 may then execute the command translation code 110 to translate the received commands into the protocol used by the hardware command processor 104 to provide a command to the indicator lamp.

In addition to the hardware input indicia commands that may be processed by the physical subsystem 101, various custom soft keys may be processed by the graphical subsystem 102. In one aspect, the graphical subsystem 102 may be a touchscreen device (e.g., tablet device) that has a graphics processing unit (“GPU”) 111, or other type of processor, that executes commands for displaying input indicia on a display screen 112. Various input indicia, layouts of input indicia, etc. may be modified to accommodate changes to the audio monitoring system; as a result, the remote control 100 may be modified to accommodate changes to the audio monitoring system (e.g., a change to a film sound format) without replacing the remote control 100.

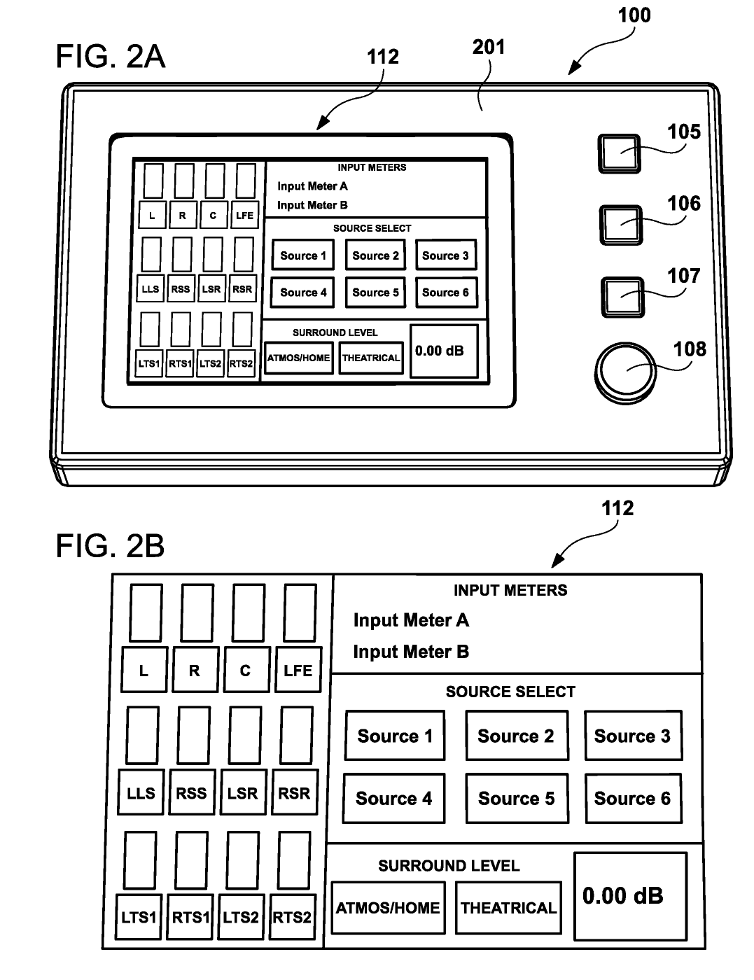

FIG. 2A illustrates an example of the exterior of the remote control 100. The remote control 100 has an enclosure 201 that encloses the internal componentry illustrated in FIG. 1. The physical buttons 105-107 may include a reference recall button 105, a dim button 106, and a mute button 107 for controlling the volume. In addition, a physical knob 108 may be used to adjust the volume. The aforementioned functionalities are provided only as examples as various other functionalities may be associated with the physical buttons 105-107.

Further, the display screen 112 of the graphical subsystem 102 may be viewed through a cutout, transparent material, etc. of the enclosure 201. A user may then provide various touch inputs with respect to various soft input indicia. For example, the display screen 112 may display speaker outputs (mute or solo control for each speaker output), individual speaker output signal metering, individual signal input source metering, source selection, surround level selection, and/or master volume fader level display. The graphical subsystem 102 allows for custom audio routing in addition to a variety of other custom input indicia.

FIG. 2B illustrates an expanded view of the display screen 112 illustrated by FIG. 2A. The various input indicia are illustrated only as examples as the graphical subsystem 102 may be modified for adaptations to an audio environment (e.g., a change in the number of speakers, types of sources, etc.).

In addition, the physical subsystem 101 and the graphical subsystem 102 may communicate with each other. For example, the physical subsystem 101 may provide data received from the physical knob 108 with respect to volume control so that the display screen 112 displays the corresponding decibel level. As a result, a user may view the volume level on the display screen 112 as the physical knob 108 is moved.

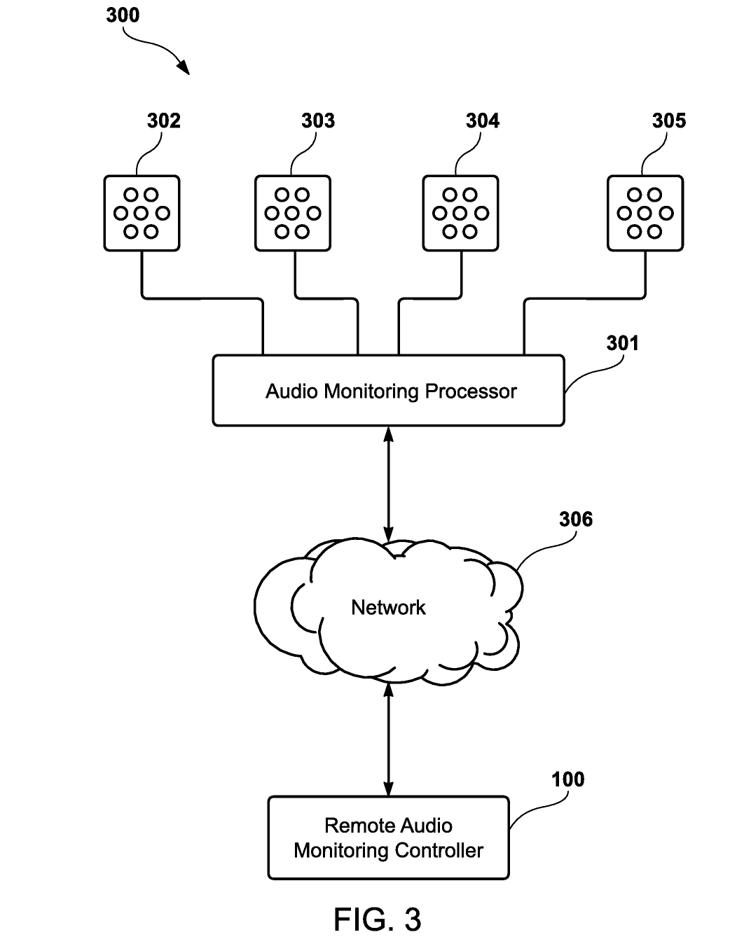

FIG. 3 illustrates an audio monitoring system 300 that uses the remote control 100 illustrated in FIGS. 1, 2A, and 2B to control audio via an audio monitoring processor 301. The audio monitoring processor 301 controls physical volume output to a variety of audio speakers 302-305. For instance, in one aspect, the audio monitoring processor 301 is situated in physical proximity to the audio speakers 302-305 and is connected to the audio speakers 302-305 via one or more physical cables. The remote control 100 may be situated in proximity to the user so that the user may monitor the audio and provide inputs in a remote location from that of the audio monitoring processor 301. As an example, a user may be situated in a control booth in a theater environment whereby the audio monitoring processor 301 is situated at a distance from the user. The remote control 100 may send input commands from the user via a network 306 (wired or wireless) in a translated format according to the protocol of the audio monitoring processor 301 to adjust audio monitoring characteristics (e.g., level, surround format, etc.) as reproduced in a given listening (i.e., monitoring) environment that may include the audio speakers 302-305.

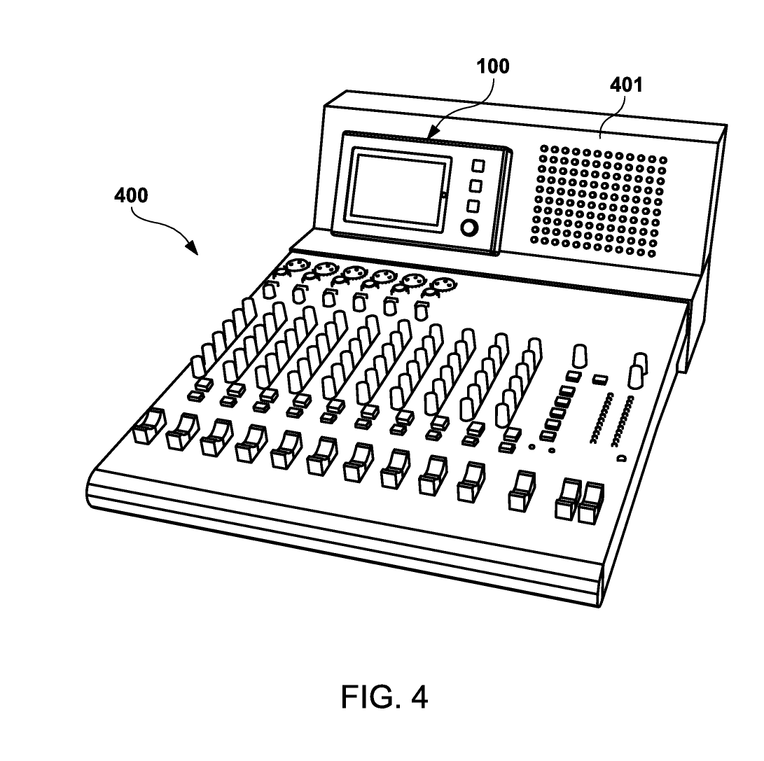

FIG. 4 illustrates a sound recording environment 400 in which the remote control 100 illustrated in FIGS. 1-3 may be used in conjunction with a mixing console 401. The mixing console 401 may be used to combine various sounds into a reproducible, production-quality product (e.g., a song stored on a compact disc). The remote control 100 changes various audio monitoring characteristics of a sound recording within a particular sound recording environment 400 independent of the product generated within the sound recording environment 400.

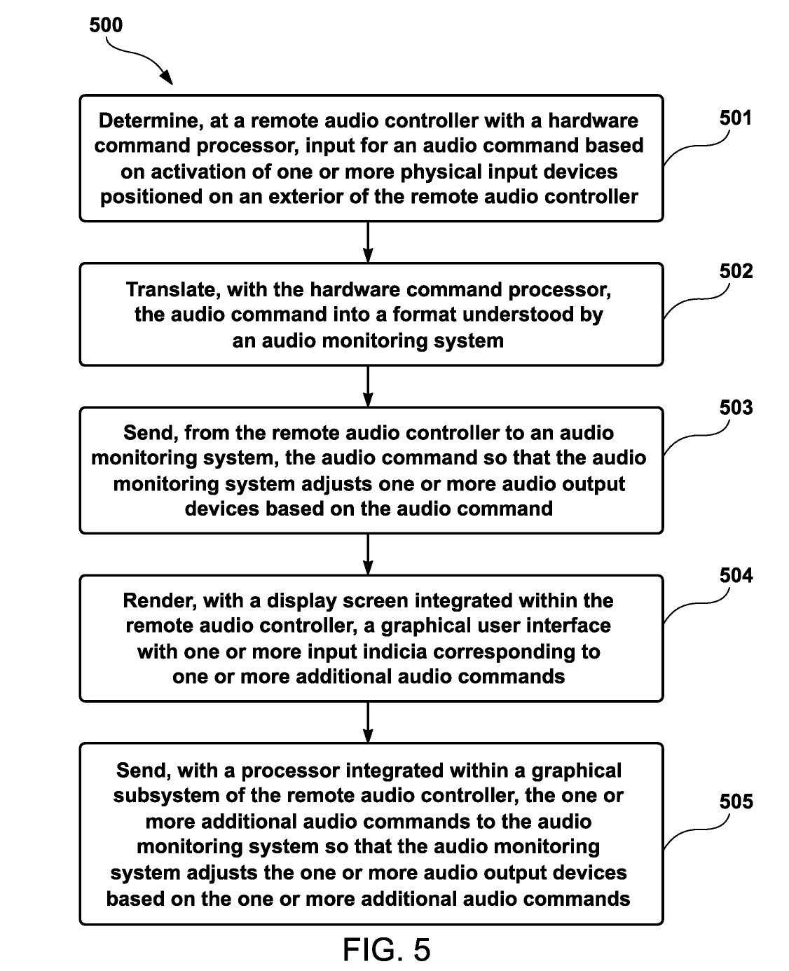

Further, FIG. 5 illustrates a process 500 that may be utilized by the remote control 100 illustrated in FIG. 1. At a process block 501, the process 500 determines, at the remote control 100 with the hardware command processor 104, input for an audio command based on activation of one or more physical input devices 105-108 positioned on an exterior of the remote control 100. The audio command is provided by the hardware command processor 104. Further, at a process block 502, the process 500 translates, with the hardware command processor 104, the audio command into a format understood by the audio monitoring system 300 (FIG. 3). The audio monitoring system 300 is remotely situated from the hardware command processor 104.

In addition, at a process block 503, the process 500 sends, from the remote control 100 to the audio monitoring system 300, the audio command so that the audio monitoring system 300 adjusts one or more audio output devices 302-305 based on the audio command. At a process block 504, the process 500 renders, with the display screen 112 integrated within the remote control 100, a graphical user interface with one or more input indicia corresponding to one or more additional audio commands. The one or more additional audio commands are distinct from the audio command. Further, at a process block 504, the process 500 sends, with the processor 111 integrated within the graphical subsystem 102 of the remote control 100, the one or more additional audio commands to the audio monitoring system 300 so that the audio monitoring system 300 adjusts the one or more audio output devices 302-305 based on the one or more additional audio commands.

The processes described herein may be implemented in a specialized processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool. A computer readable medium may be any medium, e.g., computer readable storage device, capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network. A computer is herein intended to include any device that has a specialized, general, multi-purpose, or single purpose processor as described above. For example, a computer may be a desktop computer, laptop, smartphone, tablet device, set top box, etc.

It is understood that the apparatuses, systems, computer program products, and processes described herein may also be applied in other types of apparatuses, systems, computer program products, and processes. Those skilled in the art will appreciate that the various adaptations and modifications of the aspects of the apparatuses, systems, computer program products, and processes described herein may be configured without departing from the scope and spirit of the present apparatuses, systems, computer program products, and processes. Therefore, it is to be understood that, within the scope of the appended claims, the present apparatuses, systems, computer program products, and processes may be practiced other than as specifically described herein.

1. A remote control comprising:
a physical subsystem comprising a hardware command processor and one or more physical input devices, the hardware command processor determining an input for an audio command based on activation of the one or more physical input devices, the hardware command processor translating the audio command into a format understood by an audio monitoring system, the hardware command processor sending the translated audio command to the audio monitoring system so that the audio monitoring system adjusts one or more audio output devices based on the audio command, the audio monitoring system being remotely situated from the physical subsystem, the audio command being provided by the hardware command processor; and
a graphical subsystem comprising a display screen and a display processor rendering a graphical user interface on the display screen, the graphical user interface depicting one or more input indicia corresponding to one or more additional audio commands, the one or more additional audio commands being distinct from the audio command, the processor sending the one or more additional audio commands to the audio monitoring system so that the audio monitoring system adjusts the one or more audio output devices based on the one or more additional audio commands, the audio monitoring system being remotely situated from the graphical subsystem.

2. The remote control of claim 1, wherein the display processor determines the one or more additional audio commands in a same format, without translation, as a format of the audio monitoring system.

3. The remote control of claim 1, wherein the display processor modifies the graphical user interface based on a modification to one or more parameters performed by the audio monitoring system.

4. The remote control of claim 3, wherein the display processor modifies the graphical user interface without a modification to the physical subsystem being performed by the hardware command processor.

5. The remote control of claim 3, wherein the one or more parameters are selected from the group consisting of: a change in a number of audio speakers in operable communication with the audio monitoring system and a change in a type of audio source providing audio to the audio monitoring system.

6. The remote control of claim 1, wherein the graphical subsystem comprises a touchscreen device.

7. The remote control of claim 6, wherein the remote control further comprises an enclosure for the physical subsystem and the graphical system such that the touchscreen device is visible within the enclosure.

8. A system comprising:
an audio monitoring system that is in operable communication with one or more audio output devices; and
a remote control comprising:
a physical subsystem comprising a hardware command processor and one or more physical input devices, the hardware command processor determining an input for an audio command based on activation of the one or more physical input devices, the hardware command processor translating the audio command into a format understood by an audio monitoring system, the hardware command processor sending the translated audio command to the audio monitoring system so that the audio monitoring system adjusts one or more audio output devices based on the audio command, the audio monitoring system being remotely situated from the physical subsystem, the audio command being provided by the hardware command processor, and
a graphical subsystem comprising a display screen and a display processor rendering a graphical user interface on the display screen, the graphical user interface depicting one or more input indicia corresponding to one or more additional audio commands, the one or more additional audio commands being distinct from the audio command, the processor sending the one or more additional audio commands to the audio monitoring system so that the audio monitoring system adjusts the one or more audio output devices based on the one or more additional audio commands, the audio monitoring system being remotely situated from the graphical subsystem.

9. The system of claim 8, wherein the display processor determines the one or more additional audio commands in a same format, without translation, as a format of the audio monitoring system.

10. The system of claim 8, wherein the display processor modifies the graphical user interface based on a modification to one or more parameters performed by the audio monitoring system.

11. The system of claim 10, wherein the display processor modifies the graphical user interface without a modification to the physical subsystem being performed by the hardware command processor.

12. The system of claim 10, wherein the one or more parameters are selected from the group consisting of: a change in a number of audio speakers in operable communication with the audio monitoring system and a change in a type of audio source providing audio to the audio monitoring system.

13. The system of claim 8 of claim, wherein the graphical subsystem comprises a touchscreen device.

14. The system of claim 13, wherein the remote control further comprises an enclosure for the physical subsystem and the graphical system such that the touchscreen device is visible within the enclosure.

15. A method comprising:
determining, at a remote control with a hardware command processor, input for an audio command based on activation of one or more physical input devices positioned on an exterior of the remote control, the audio command being provided by the hardware command processor;
translating, with the hardware command processor, the audio command into a format understood by an audio monitoring system, the audio monitoring system being remotely situated from the hardware command processor;
sending, from the remote control to an audio monitoring system, the audio command so that the audio monitoring system adjusts one or more audio output devices based on the audio command;
rendering, with a display screen integrated within the remote control, a graphical user interface with one or more input indicia corresponding to one or more additional audio commands, the one or more additional audio commands being distinct from the audio command; and
sending, with a processor integrated within a graphical subsystem of the remote control, the one or more additional audio commands to the audio monitoring system so that the audio monitoring system adjusts the one or more audio output devices based on the one or more additional audio commands.

16. The method of claim 15, further comprising determining the one or more additional audio commands in a same format, without translation, as a format of the audio monitoring system.

17. The method of claim 15, further comprising modifying the graphical user interface based on a modification to one or more parameters performed by the audio monitoring system.

18. The method of claim 17, further comprising modifying the graphical user interface without a modification to a physical subsystem associated with the hardware command processor.

19. The method of claim 17, wherein the one or more parameters are selected from the group consisting of: a change in a number of audio speakers in operable communication with the audio monitoring system and a change in a type of audio source providing audio to the audio monitoring system.

20. The method of claim 19, wherein the graphical subsystem comprises a touchscreen device.
